(19) United States
(12) Patent Application Publication
(10) Pub. No.: US 2008/0267582 A1
(43) Pub. Date: Oct. 30, 2008

(54) IMAGE PROCESSING APPARATUS AND IMAGE PROCESSING METHOD

(76) Inventor: Yasunobu YAMAUCHI, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/049,455

(22) Filed: Mar. 17, 2008

(30) Foreign Application Priority Data
Apr. 26, 2007 (JP) 2007-117577

(51) Int. Cl. H04N 5/93; G06K 9/46

(52) U.S. Cl. 386/52; 382/190

(57) ABSTRACT

An image processing apparatus extracts plural image frames relevant to representative frames from among a series of the image frames constituting image data, allocates in time series of image times the plural image frames to plural medium frames laid out within a display virtual space, sequentially determines one attention frame from among the plural medium frames, and performs image processing of highlighting an image frame allocated to the attention frame, to the image frame allocated to each medium frame.

### CROSS-REFERENCE TO RELATED APPLICATIONS

This application is based upon and claims the benefit of priority from the prior Japanese Patent Application No. 2007-117577, filed on Apr. 26, 2007; the entire contents of which are incorporated herein by reference.

### BACKGROUND OF THE INVENTION

1. Field of the Invention

The present invention relates to an image processing apparatus and an image processing method.

2. Description of the Related Art

The usage of thumbnails is generally known as a method of expressing image data such as a video image. According to this method, usually, an image frame after a lapse of a header image frame or after a predetermined time (predetermined number of frames) from the header is displayed as a thumbnail image. A method called an animation thumbnail using a video image not a still image, as a thumbnail image is also present. In the case of this animation thumbnail, usually, a start and an end of an animation part are connected, and are repeatedly reproduced. As a method of expressing the content of the video image, a method called a chapter division based on a cut detection of an image scene is present. When this chapter division is used, each part animation image in the chapter unit is expressed by thumbnail.

Meanwhile, in the usage of listing or editing the content of a vide image, a method of displaying an image frame constituting a video image by relating the image frame to a time line is generally used. When the image frames are attempted to be laid out by avoiding a overlay of the image frames within a screen, work of changing a scale of the time line or the like is necessary. On the other hand, when information of the image frame constituting the video image is attempted to be laid out within a limited image area, the image frames are overlaid with each other, and the respective image frames cannot be observed easily.

Therefore, Ramos et al., Fluid interaction techniques for the control and annotation of digital video, Proceedings of the 16th annual ACM Symposium on User Interface Software and Technology pp. 105-114 (2003), or the like disclose a method of decreasing the inconvenience of overlay by changing the layout of image frames present around the image frame to be operated. Irani et al., Efficient Representation of Video Sequence and Their Applications, Signal processing: Image communication (Journal): pp. 327-351 (1996) disclose a method of displaying a movement track of an object present within each image frame, by overlaying image frames constituting a vide image, after keeping consistency of backgrounds of the image frames. Further, Teodosio et al., Salient stills, ACM Transactions on Multimedia Computing, Communications, and Applications (TOMCAAP), Volume 1, Issue 1 pp. 16-36 (2005), and Agarwala et al., Interactive digital photomontage, ACM Siggraph 2004 pp. 294-302 (2004) disclose methods of arranging plural image frames constituting a video image using high image-correlation of time space, and combining the image frames into one image by keeping consistency of the image frames.

However, according to the method of using thumbnails, only one image frame is extracted from a series of image frames constituting a video image. Therefore, it is sometimes difficult to search a target video image based on the thumbnail from plural video images. In the case of a video image obtained by recording a certain program from a starting time of the broadcasting, for example, there is a risk that the header of the video image is the same as the image of the program title. In this case, the same program recorded on different dates cannot be distinguished based on only the thumbnail. According to the animation thumbnail method, when there is no correlation between the starting image and the ending image of the video image, the images are discontinuous and are difficult to observe. Because the starting image and the ending image cannot be easily distinguished, it is difficult to understand the flow of images by only looking at the animation thumbnail.

On the other hand, the method disclosed by the above Ramos et al. has a problem in that when the layout of the image frames located around are changed, directionality of the movement between the image frames and the flow of images become unclear. According to the method disclosed by Irani et al., plural image frames are displayed at the same time. Therefore, a time-series movement of an object about from which direction this object comes and to which direction this object leaves cannot be expressed. Further, according to the methods disclosed by Teodosio et al., and by Agarwala et al., states of a moving object at plural times are simultaneously displayed together with the expression of the track of the object. Therefore, the directionality of the movement and the flow of the images cannot be clearly expressed.

As explained above, according to the above conventional methods, it is difficult to make users understand a time relationship of image data and a flow of the image.

### SUMMARY OF THE INVENTION

According to one aspect of the present invention, an image processing apparatus includes a representative-frame determining unit that determines a representative frame from a series of image frames constituting image data; a part-video-image determining unit that determines a part of a video image including a plurality of image frames relevant to the representative frames from the series of image frames; a medium-frame setting unit sets a plurality of frames as a display medium of the image frame, within a display virtual space; an allocating unit that allocates image frames contained in the part of the video image to each medium frame in time sequences of the video image, according to a layout relationship of the medium frames, the layout within the display virtual space; an attention-frame determining unit that sequentially determines one attention frame from among the plurality of medium frames; and an image processing unit that performs image processing of highlighting an image frame allocated to the attention frame, to an image frame allocated to each medium frame.

According to another aspect of the present invention, an image processing method includes determining a representative frame representing image data from a series of image frames constituting the image data; determining a part of a video image including a plurality of image frames relevant to the representative frames from the series of image frames; disposing a plurality of frames as a display medium of the image frame, within a display virtual space; allocating image frames contained in the part of the video image to each medium frame in time series of image times, according to a layout relationship of the medium frames; sequentially determining one attention frame from among the plurality of medium frames; and performing image processing of highlighting an image frame allocated to the attention frame, to an image frame allocated to each medium frame.

### BRIEF DESCRIPTION OF THE DRAWINGS

FIG. 1 is a diagram illustrating a hardware configuration of an image processing apparatus;

FIG. 2 is a diagram illustrating a functional configuration of an image processing apparatus according to a first embodiment of the present invention;

FIG. 3 is a flowchart of an order of a representative image display process;

FIG. 4 is a diagram illustrating an example of a layout of medium frames;

FIG. 5 is a diagram illustrating an example of another layout of medium frames;

FIG. 6 is a flowchart of an order of image processing according to the first embodiment;

FIG. 7 is a diagram illustrating a relationship between an attention frame and a medium frame;

FIG. 8 is a diagram illustrating transparency models;

FIG. 9 is a schematic diagram for explaining a transition of an attention frame;

FIG. 10 is a diagram illustrating an example of still another layout of medium frames;

FIG. 11 is a diagram illustrating an example of still another layout of medium frames;

FIG. 12 is a diagram illustrating a functional configuration of an image processing apparatus according to a second embodiment of the present invention;

FIG. 13 is a flowchart of an order of image processing according to the second embodiment;

FIG. 14 is a diagram illustrating a blur processing model;

FIG. 15 is a diagram illustrating a relationship between an attention frame and a medium frame;

FIG. 16 is a diagram illustrating a relationship between medium frames;

FIG. 17 is a diagram illustrating a relationship between a medium frame and a camera viewpoint;

FIG. 18 is a diagram illustrating a functional configuration of an image processing apparatus according to a third embodiment of the present invention;

FIG. 19 is a flowchart of an order of image processing according to the third embodiment;

FIG. 20 is a schematic diagram for explaining a reference frame;

FIG. 21 is a schematic diagram for explaining a blurring process; and

FIG. 22 is a diagram illustrating a curve pattern expressed by a correction function of edge intensity.

### DETAILED DESCRIPTION OF THE INVENTION

Exemplary embodiments of an image processing apparatus and an image processing method according to the present invention will be explained below in detail with reference to the accompanying drawings.

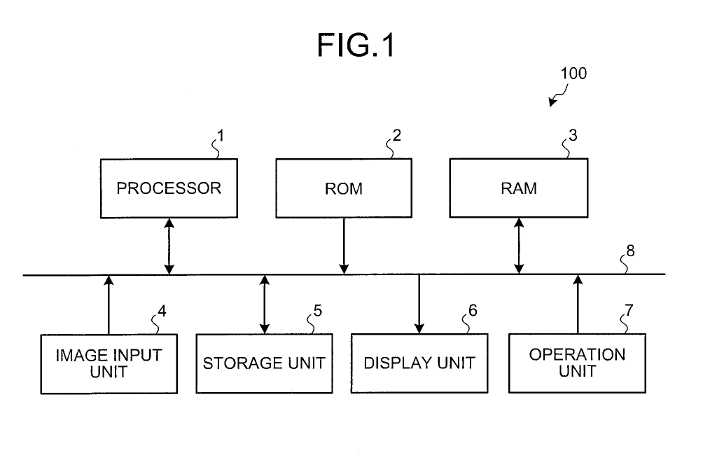

FIG. 1 is a block diagram of a hardware configuration of an image processing apparatus 100. As shown in FIG. 1, the image processing apparatus 100 includes a processor 1, a read only memory (ROM) 2, a random access memory (RAM) 3, an image input unit 4, a storage unit 5, a display unit 6, and an operation unit 7. These units are connected to each other via a bus 8.

The processor 1 includes a central processing unit (CPU), a graphics processing unit (GPU), a digital signal processor (DSP), and a numerical processor. The processor 1 collectively controls the units of the image processing apparatus 100 by executing a predetermined program (such as an image processing program) stored in the storage unit 5.

The ROM 2 is a storage device exclusively used to read stored information such as Basic Input/Output System (BIOS). The RAM 3 is a volatile storage device that rewritably temporarily stores various kinds of data. The RAM 3 also functions as a video-image storage unit 16 described later, using a part of the storage area of the RAM 3.

The image input unit 4 is a processing unit that inputs a video image recorded in a recording medium such as a digital versatile disk (DVD) medium and a hard disk drive device, or a video image received by a network. In a first embodiment of the present invention, the “video image” means image data including plural image frames.

The storage unit 5 stores a program, a parameter, and various kinds of set information (such as a transparency model described later) to achieve a representative image display process described later, and stores a video image input from the image input unit 4.

The display unit 6 includes a liquid crystal display (LCD), a cathode ray tube (CRT), etc., and displays various kinds of information based on a display signal from the processor 1. The display unit 6 displays a display virtual space described later on a screen, under the control of the processor 1, thereby displaying an image frame adhered to a medium frame within the virtual space.

The operating unit 7 includes various kinds of input keys, receives information input by users as input signals, and outputs the input signals to the processor 1.

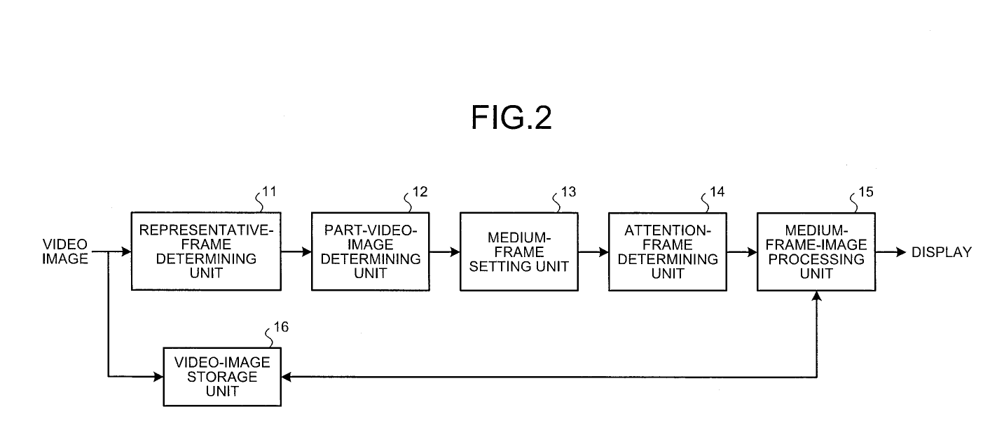

FIG. 2 is a block diagram of a functional configuration of the image processing apparatus 100 according to the first embodiment. As shown in FIG. 2, the processor 1 controls various units following a predetermined program stored in the storage unit 5, to include a representative-frame determining unit 11, a part-video-image determining unit 12, a medium-frame setting unit 13, an attention-frame determining unit 14, and a medium-frame-image processing unit 15. The video-image storage unit 16 corresponds to the RAM 3, and temporarily stores a vide image input from the image input unit 4 or a video image stored in the storage unit 5.

The representative-frame determining unit 11 determines an image frame representing image data as a representative frame, from a series of image frames constituting the image data. The representative frame can be determined using a video-image allocation method for allocating video images to the conventional thumbnail. For example, the representative frame can be a starting frame of a video image, or can be an image frame after a lapse of certain time (a few seconds) since the starting time.

When a representative frame is determined in a chapter unit divided by a chapter division or the like, plural representative frames are present for one program. A conventional method can be used to determine a representative frame in each chapter. A representative frame can be also determined based on a “enthusiastic level” obtained by calculation based on voice information (for example, “height”, “intensity”, and “speed”) attached to a video image.

The part-video-image determining unit 12 determines part-video-images as plural image frames relevant to a representative frame, from a series of image frames constituting image data. Specifically, the part-video-image determining unit 12 determines image frames within a predetermined time range positioned before and after a representative frame including the representative frame, as part-video-images.

The time range can be assigned in frame unit such as 300 frames before and after a representative frame, or can be assigned in time unit as 10 seconds before and after the representative frame. For example, when ten frames before and after a representative frame are set as part-video-images by assigning in frame unit, a number of frames included in the part-video-images is 21 including the representative frame (that is, a sum of ten frames in the forward direction, ten frames in the backward direction, and the representative frame, on a time axis). In this case, the forward direction means a header-frame direction of video images, and the backward direction means a tail-frame direction of the vide images.

Time frames different in the forward direction and the backward direction respectively of a representative frame (for example, 10 seconds in the forward direction, and 20 seconds in the backward direction) can be set, or numbers of frames different in the forward direction and the backward direction (for example, ten frames in the forward direction, and 20 frames in the backward direction) can be set. A range of frames of which image correlation with a representative frame becomes equal to or higher than a predetermined threshold value can be determined as part-video-images. In this case, part-video-images can be determined within a time range in which images similar to a representative frame continues. When video images are chapter divided in advance, the total video images of the chapter including the representative frame can be set as part-video-images.

The medium-frame setting unit 13 generates plural medium frames becoming a display medium of an image frame, within a display virtual space, and determines a layout, a posture, and a shape of each medium frame. The medium-frame setting unit 13 allocates image frames included in the part-video-images to the medium frames in time sequence of the image time, according to the layout relationship of the medium frames, thereby determining an image frame to be displayed. The image time means the time when each image frame is located on the time axis of the video image.

The attention-frame determining unit 14 determines one medium frame to which attention should be paid by users, as an attention frame, from among plural medium frames generated by the medium-frame setting unit 13. The attention-frame determining unit 14 sequentially changes over between medium frames becoming an attention frame to control such that each medium frame becomes an attention frame.

The medium-frame-image processing unit 15 reads an image frame allocated to a medium frame, from the video-image storage unit 16, performs predetermined image processing to each image frame based on the attention frame determined by the attention-frame determining unit 14, and applies the image frame to the corresponding medium frame, thereby displaying the image-processed image frame on the display unit 6. In this case, the known texture mapping method is used to apply the image frame. An image frame allocated to a medium frame, that is, an image frame read out from the video-image storage unit 16, is hereinafter called a “medium frame image”.

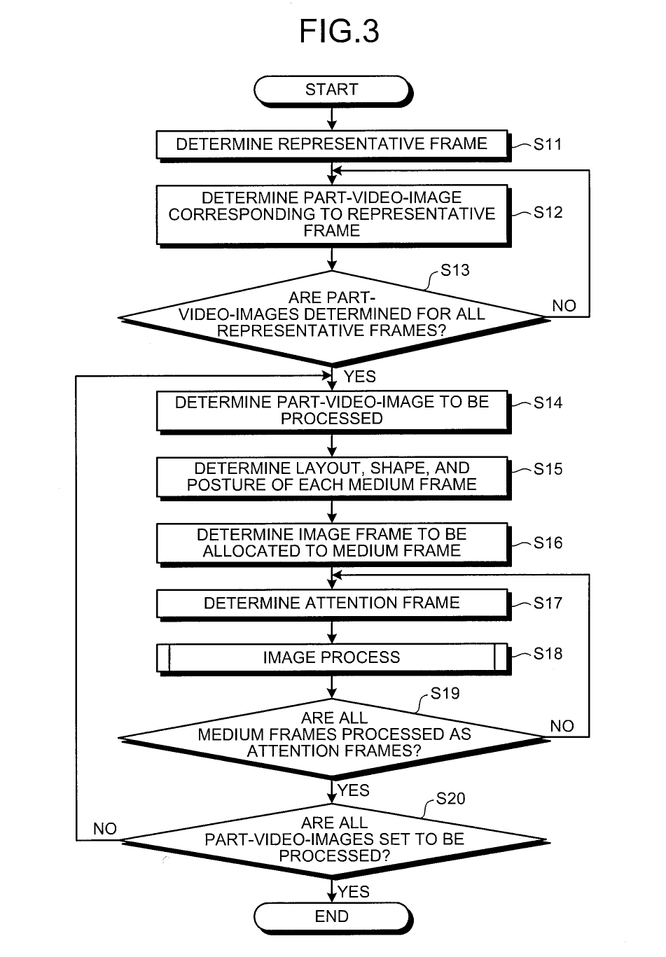

The operation of the image processing apparatus 100 according to the first embodiment is explained below. FIG. 3 is a flowchart of an order of a representative image display process performed by the image processing apparatus 100.

First, when the image input unit 4 or the storage unit 5 inputs a video image, the representative-frame determining unit 11 determines a specific image frame out of plural image frames constituting this video image, as a representative frame (step S11). When this video image is chapter divided, a representative frame is determined for each divided video image.

Next, the part-video-image determining unit 12 determines part-video-images according to the representative frames, for each representative frame determined at step S11 (step S12). The part-video-image determining unit 12 determines whether part-video-images are determined for all representative frames. When it is determined that a representative frame for which a part-video-image is not determined is present (NO at step S13), the process returns to step S12, and the part-video-image determining unit 12 determines a part-video-image for this representative frame.

On the other hand, when the part-video-image determining unit 12 determines at step S13 that part-video-images are determined for all representative frames determined at step S11 (YES at step S13), the process proceeds to step S14.

At step S14, the medium-frame setting unit 13 determines one part-video-image to be processed, from among the part-video-images determined at step S13 (step S14). When there is only one part-video-image determined at step S13, this part-video-image is to be immediately processed. When plural part-video-images are present, a part-video-image to be processed is determined based on the order determined at step S13 or based on a time relationship of image times of the representative frames included in the parts video images. However, the method of determining a part-video-image is not limited to this.

The medium-frame setting unit 13 generates plural medium frames becoming mediums in displaying image frames on the screen, within the display virtual space, and determines a layout, a shape, and a posture of each medium frame (step S15). A number of the medium frames to be generated is not particularly limited, and can be a fixed value such as 11, or can be determined according to the number and content of image frames contained in the part-video-images, for example.

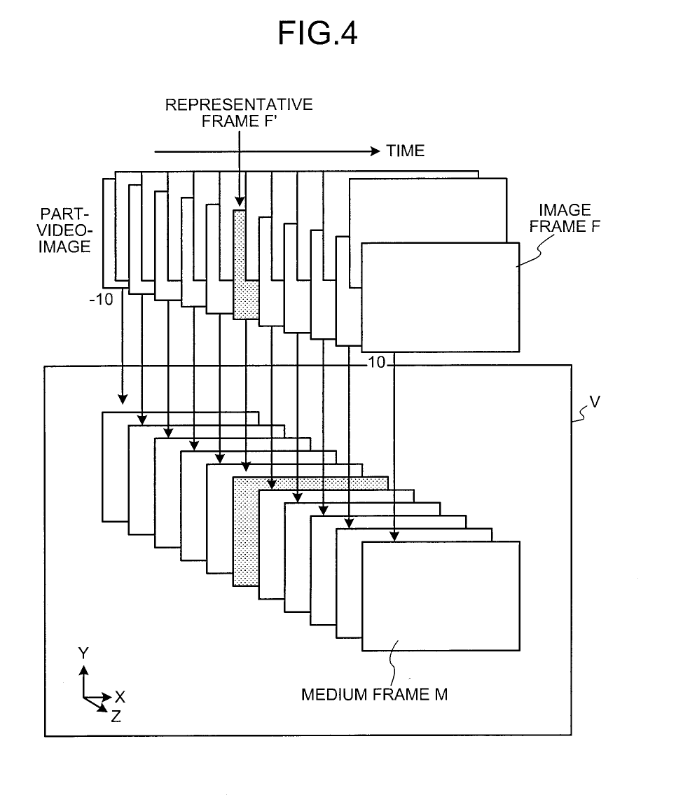

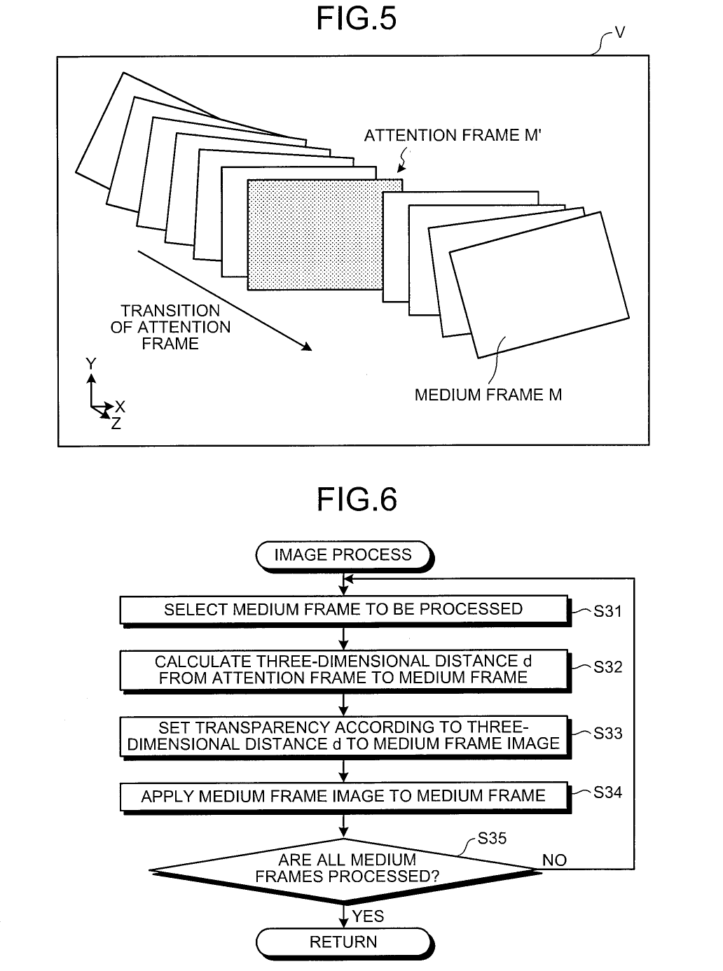

The process at step S15 is explained below with reference to FIGS. 4 and 5. In the first embodiment, while a quadrate object is laid out as a medium frame within a three-dimensional virtual space, a shape of the medium frame is not limited to this.

FIG. 4 is a diagram illustrating an example of a state that 11 medium frames M are laid out by shifting the medium frames by a predetermined amount in image directions (XY axis directions) and a depth direction (Z axis direction), respectively, within a virtual space V. Specifically, when positions of an i-th (i=1 to 11) medium frame M on the X, Y, Z axes are defined as (P(i)·x, P(i)·y, and P(i)·z), relational expressions concerning a determination of these positions are set as the following expressions (1) to (3). Based on this setting, the layout as shown in FIG. 4 can be achieved. In the following expressions (1) to (3), “Sx”, “Sy”, and “Sz” are scaling parameters for controlling the layout of the medium frame on each axis, and “imax” means a total number (“11” in the case of FIG. 4) of medium frames.

P(i)·x=Sx·(i/imax−0.5) (1)

P(i)·y=Sy·(i/imax−0.5) (2)

P(i)·z=Sz·(i/imax−0.5) (3)

Postures of medium frames can be similarly controlled. Specifically, when rotation angles around the axes (X, Y, Z) are defined as (R(i)·x, R(i)·y, R(i)·z) as a posture of the i-th medium frame, relational expressions concerning a determination of the rotation angles are set as the following expressions (4) to (6). Based on this setting, the medium frame can be controlled in an optional posture. In the following expressions (4) to (6), “Rx”, “Ry”, and “Rz” are scaling parameters for controlling the posture of the medium frame around each axis.

R(i)·x=Rx·(i/imax−0.5) (4)

R(i)·y=Ry·(i/imax−0.5) (5)

R(i)·z=Rz·(i/imax−0.5) (6)

When Rx and Ry are set to “0.0”, the medium frames M rotated by a predetermined amount around the Z axis are laid out within the virtual space V, as shown in FIG. 5. The layout and the posture of the medium frames are not limited to the above, and the medium frames can be set in optional layouts and postures.

Sizes of the medium frames can be also individually set for the medium frames, like the “layout” and the “posture”. For example, when a quadrate object is used as the medium frame M as shown in FIGS. 4 and 5, image frames can be displayed without distortion, when both an aspect ratio of a surface (surface perpendicular to the Z axis) to which the image frames are applied as a texture and an aspect ratio of video images are set equal.

When an aspect ratio of a surface to which the image frames are applied on the medium frames and an aspect ratio of the video images are different, video images having no distortion can be applied, by adjusting texture coordinates at the texture mapping time. Specifically, at the time of applying textures to the whole surface of the medium frames, a setting of the texture coordinates can be normalized (set to 0.0 to 1.0) by matching a long axis in the aspect ratio of the video images, and the texture coordinates on the medium frames can be expanded in the form of including a short axis.

As explained above, the medium-frame setting unit 13 controls a layout and a posture of the medium frames M within the virtual space V, by setting sizes, an aspect ratio, and a depth ratio, setting a shape, and setting a layout position within the virtual space V and rotation angles around the three axes, of the medium frames M, respectively.

While a quadrate object is used as a substance of a medium frame above, when a texture mapping of image frames can be performed, an optional three-dimensional model can be also set as a medium frame. For example, a simple shape such as a sphere and a cylinder can be also used. An optional surface curvature that can be generally assigned in a mesh shape can be also used. In this case, a size of a medium frame can be assigned as a size of a bounding volume of a corresponding three-dimensional model.

Referring back to FIG. 3, at step S16, the medium-frame setting unit 13 allocates image frames to be displayed, to medium frames in time sequences of video-image, from among image frames contained in the part-video-images to be processed, according to the layout of the medium frames, thereby determining image frames to be displayed (step S16).

For example, 21 image frames F are contained in the part-video-images, for 11 medium frames M, in the example shown in FIG. 4. Therefore, 11 image frames F need to be selected from the part-video-images. In this case, as shown in FIG. 4, the medium-frame setting unit 13 selects two image frames F before and after a representative frame F′, respectively around the representative frame F′, thereby selecting image frames F of the same number as that of the medium frames M, for display.

The medium-frame setting unit 13 allocates the selected 11 image frames F (total of the representative frame F′, five frames in the time forward direction from the representative frame F′, and five frames in the backward direction) in time sequences of video-image, to the medium frames M, according to the layout direction of the medium frame M. While a method of selecting the image frames to be displayed from the part-video-images is not limited to the one shown in FIG. 4, it is preferable to select the image frames based on the representative frame F′.

Referring back to FIG. 3, the attention-frame determining unit 14 determines a medium frame from among plural medium frames, as an attention frame (step S17). As described later, preferably, a medium frame to be used for the attention frame is determined from the back toward the front medium within the virtual space, that is, in time sequences of video-image of the image frames allocated to the medium frames.

At step S18, the medium-frame-image processing unit 15 reads image frames (medium frame images) allocated to the medium frames, from the video-image storage unit 16, and performs predetermined image processing to each medium frame, based on the attention frame determined by the attention-frame determining unit 14 (step S18). The image processing at step S18 is explained with reference to FIGS. 6 to 8.

FIG. 6 is a flowchart of an order of the image processing at step S18. First, the medium-frame-image processing unit 15 selects one medium frame to be processed, from among plural medium frames (step S31).

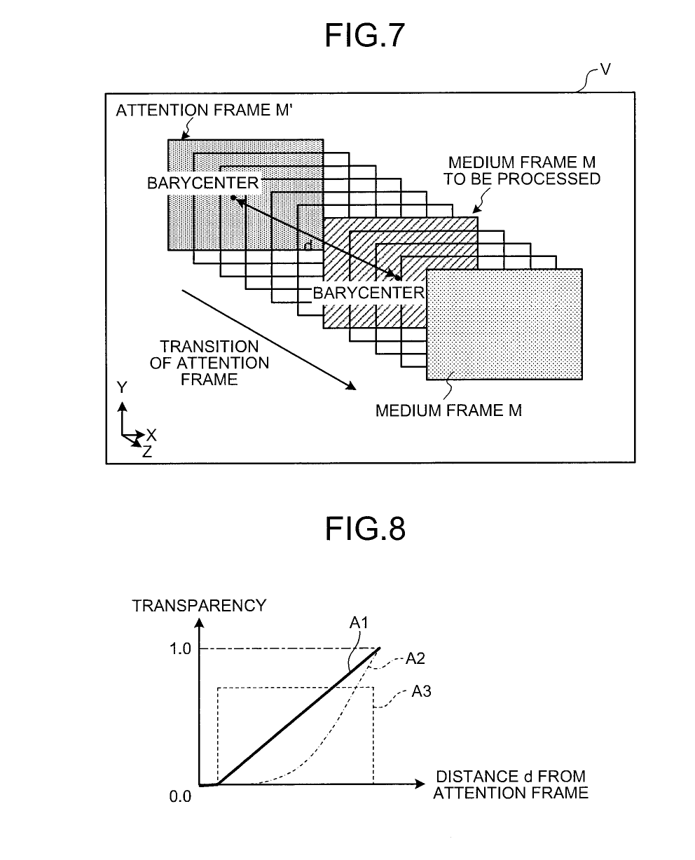

The medium-frame-image processing unit 15 calculates a three-dimensional distance d from the attention frame determined at step S17 to the medium frame to be processed (step S32). Specifically, as shown in FIG. 7, a barycenter of a medium frames M is set as a three-dimensional position representing the medium frame. A distance between the barycenter of an attention frame M′ and the barycenter of the medium frame M to be processed is calculated as the three-dimensional distance d between both frames. When shapes of both medium frames are the same, a distance between the same positions, such as the left upper positions, of both frames is calculated.

The medium-frame-image processing unit 15 sets transparency T (d) of the medium frame image allocated to the medium frame to be processed, according to a value of the three-dimensional distance d calculated at step S32, thereby changing the transparency of the medium frame image when it is displayed in the display unit 6 (step S33).

Specifically, the medium-frame-image processing unit 15 determines the transparency T (d) according to the three-dimensional distance d between both frames, based on a transparency model having the three-dimensional distance d and the transparency T (d) uniquely related to each other, and sets the specified transparency T (d) to the medium frame to be processed.

FIG. 8 is a diagram illustrating three transparency models (transparency models A1 to A3) in a graph. In the transparency models explained below, it is assumed that a maximum three-dimensional distance dmax is normalized to 1.0, in all combinations of medium frames.

FIG. 8 expresses the three transparency models A1 to A3 as representative patterns for transmitting parts other than the periphery of the attention frame. In FIG. 8, the vertical axis of the graph expresses transparency, and “0.0” means nontransparency. When this numerical value increases, transparency increases.

When the attention frame is set nontransparent and also when the transparency of each medium frame is increased in proportion to the size of the three-dimensional distance d from the attention frame, the transparency model A1 is used. The transparency mode A1 is a curve pattern given by the following expressions (7) and (8). “Tmin” represents a minimum value of transparency, “dth” is a parameter for controlling the curve pattern, and “α” is a parameter for adjusting the transparency.

T(d)=α·d (when 1.0>d>/dth) (7)

T(d)=Tmin (when dth>d>0.0) (8)

To clearly make visible the attention frame and the medium frames at the periphery of the attention frame, the transparency model A2 is used. The transparency mode A2 is a curve pattern given by the following expression (9). “β” is a scaling coefficient for adjusting the transparency.

T(d)=β·exp(d)−1.0 (9)

To make only the attention frame nontransparent and also to make medium frames other than the attention frame uniformly transparent, the transparency model A3 is used. The transparency mode A3 is a curve pattern given by the following expressions (10) and (11). “Tmax” represents a maximum value of transparency, “Tmin” represents a minimum value of transparency, and “dth” is a parameter for controlling the curve pattern.

T(d)=Tmax (when 1.0>d>dth) (10)

T(d)=Tmin (when dth>d>0.0) (11)

In setting the transparency of each medium frame, the medium-frame-image processing unit 15 selects one transparency model from among the above transparency models A1 to A3, thereby setting and changing the transparency of the image frame applied to each medium frame. By performing the image processing described above, the attention frame can be displayed clearly, and medium frames other than the attention frame can be display in a blurred state. Therefore, there is an effect of highlighting the attention frame and also displaying other medium frames for the users at the same time.

The above relational expressions of the transparency models are stored in the ROM 2 or the storage unit 5 in advance. The medium-frame-image processing unit 15 performs the image processing (transparency) following the above transparency model based on the relational expressions stored in the ROM 2 or the storage unit 5. In setting the transparency patterns, not only the transparency models A1 to A3, but also optional functions can be set.

Referring back to FIG. 6, the medium-frame-image processing unit 15 applies the image-processed medium frame image to the corresponding medium frame, thereby displaying the medium frame image in the display unit 6 (step S34).

The medium-frame-image processing unit 15 determines whether all medium frames are processed at steps S32 to S34. When it is determined that a medium frame not yet processed is present (NO at step S35), the process returns to step S31 again, and the medium-frame-image processing unit 15 processes this medium frame. When the medium-frame-image processing unit 15 determines that all medium frames are processed at steps S32 to S34 (YES at step S35), the process proceeds to step S19 shown in FIG. 3.

Referring back to FIG. 3, the attention-frame determining unit 14 determines whether all medium frames are processed as attention frames (step S19). When it is determined that a medium frame not yet processed is present (NO at step S19), the process returns to step S17, and the attention-frame determining unit 14 determines that this medium frame is the attention frame. When the attention-frame determining unit 14 determines that all medium frames are processed as the attention frames (YES at step S19), the process proceeds to step S20.

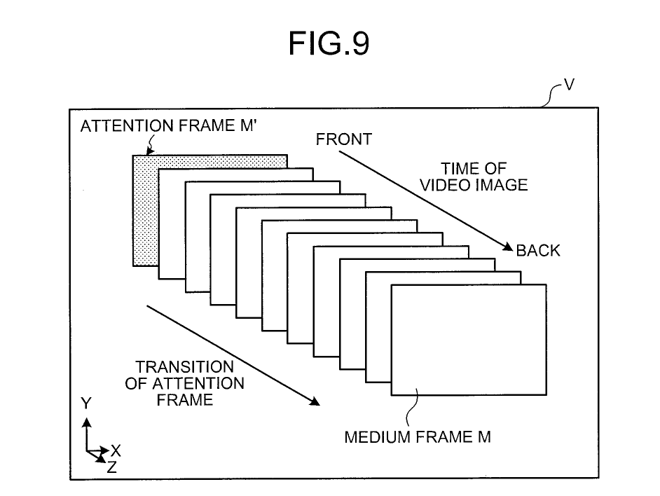

The transition of the attention frame performed by the attention-frame determining unit 14 is explained below with reference to FIG. 9. The attention-frame determining unit 14 sequentially selects one medium frame as an attention frame, from among plural medium frames, thereby controlling so that each medium frame is sequentially paid attention to.

Preferably, medium frames becoming the attention frames are determined in time sequences of video-image of the image frames according to the medium frames.

For example, when image frames are allocated to express a time lapse from the left upper side (the backmost) to the right lower side (the foremost) of the screen within the virtual space V, like the medium frames M as shown in FIG. 9, the medium frames M are sequentially determined as the attention frames M′, starting from the medium frame M laid out at the backmost toward the medium frame M at the foremost. When the attention frames are shifted according to the order of the image frames on the time axis as explained above, there is an effect that the medium frame images are displayed while moving in space, and the medium frame images applied to the medium frames at the periphery of the attention frames appear in a blurred state. A shifting speed of the attention frames, that is, a changeover speed of the medium frames as the attention frames, is optional. The medium frames can be also changed over following intervals of the image times between the medium frame images allocated to the medium frames, or can be changed over at equal intervals. Preferably, the medium frame images are changed over at time intervals at which the medium frame images appear like an animation, by shifting the attention frames.

Referring back to FIG. 3, at step S20, the medium-frame setting unit 13 determines whether all part-video-images are set to be processed (step S20). When it is determined that a part-video-image that is not set to be processed is present (NO at step S20), the process returns to step S14 again, and the medium-frame setting unit 13 processes this part-video-image.

On the other hand, at step S20, when the part-video-image determining unit 12 determines that all part-video-images are set to be processed (YES at step S20), the present process ends.

In the flowchart shown in FIG. 3, while the processes at steps S14 to S19 are performed once for each part-video-image, these processes can be performed repeatedly. In this case, a result of the image processing performed by the medium-frame-image processing unit 15 can be stored in the video-image storage unit 16, and can be used again, thereby decreasing load applied to the image processing.

As explained above, according to the first embodiment, plural image frames having relevance extracted from the image data can be simultaneously displayed in time series, and the image frames can be sequentially highlighted. Accordingly, a time flow of the image data can be displayed clearly, and users can be made conscious about each image frame. Consequently, users can be made conscious about the flow of the images such as a time relationship of the images.

Regarding the layout of medium frames performed by the medium-frame-image processing unit 15, a result of analyzing the video images obtained from the video-image storage unit 16 can be also used to layout the medium frames. For example, motion information can be extracted from image frames before and after the medium frame, regarding the image frames corresponding to the medium frames. A layout position of the medium frames can be determined based on a largest motion component. According to this layout method, motion parameters of total video images such as a pan and a tilt can be regarded as camera parameters. Therefore, a layout of medium frames reflecting the motion of the camera can be achieved.

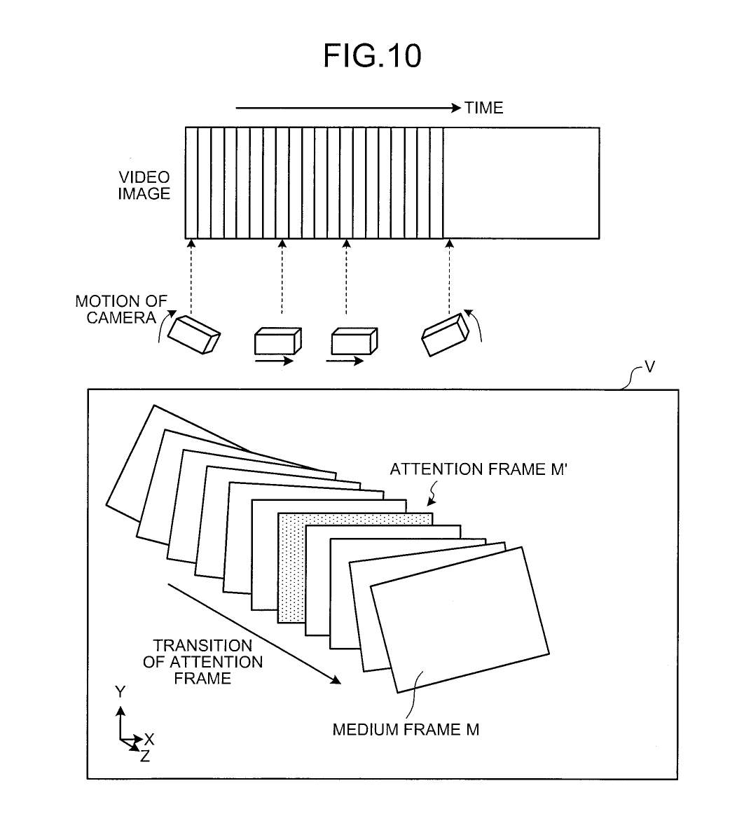

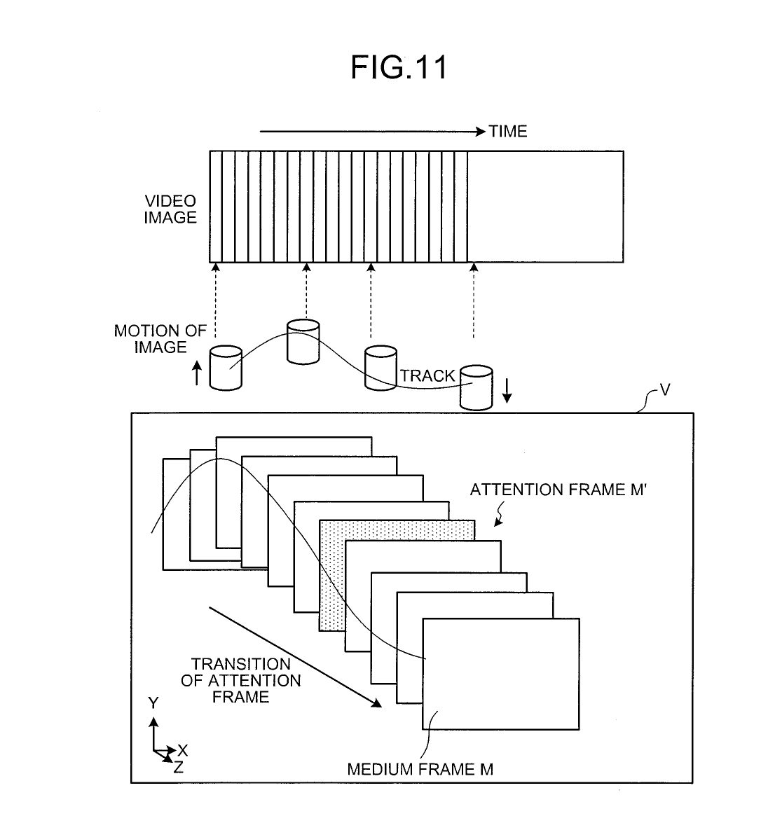

FIG. 10 is a schematic diagram for explaining the layout of the medium frames M reflecting the motion of the camera. When a scene is generated by video images panned in a lateral direction, a motion vector in a lateral direction on the screen can be extracted. Therefore, the medium frames M can be laid out at positions where the medium frames M are shifted to a lateral direction which is the same as the direction of the motion vector. When the image processing is performed to shift the attention frame M′ in this layout, the panned video images flow in time series in the lateral direction, and the image frames before and after the attention frame can be left at the same time, thereby enhancing realistic sensation.

When the background is fixed and also when characters move, motions of objects can be detected by detecting motion information from the image frames before and after the video image. When an object jumps in the Y axis direction, thumbnail of a track that repeats a shift in the Y axis direction can be generated for the layout of the medium frames M. In this way, a motion of the character appearing in the video image can be confirmed by the layout of the total medium frames M. Therefore, a new expression not present in the conventional reproduction of video images can be achieved.

According to the first embodiment, a transparency process is performed to the image frames allocated to medium frames, according to distances from the attention frame to the medium frames other than the attention frame. However, the allocation method is not limited to the above. For example, the transparency process can be performed to image frames allocated to medium frames, according to a time difference of image time from the image frame allocated to the attention frame to the image frame allocated to another medium frame other than the attention frame.

In this case, the lateral axis of the graph expressing the transparency model shown in FIG. 8 is set as a time difference from the image time of the image frame allocated to the attention frame until the image time of the image frame allocated to another medium frame. With this arrangement, the image processing of highlighting the medium frame image of the attention frame can be performed to the medium frame image of each medium frame, like in the above example.

An image processing apparatus according to a second embodiment of the present invention is explained below. Constituent elements similar to those in the first embodiment are denoted by like reference numerals, and explanations thereof will be omitted.

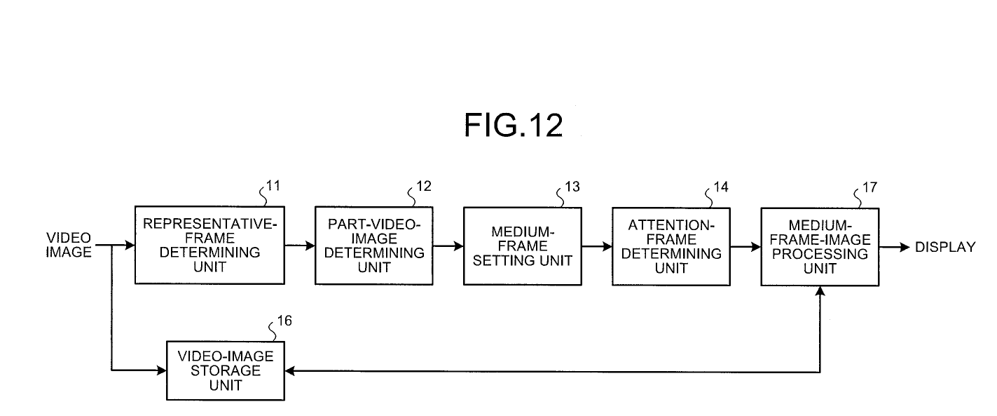

FIG. 12 is a block diagram of a functional configuration of the image processing apparatus 100 according to the second embodiment. As shown in FIG. 12, the image processing apparatus 100 includes a medium-frame-image processing unit 17 instead of the medium-frame-image processing unit 15 explained in the first embodiment, based on a control that the processor 1 performs to each unit following a predetermined program stored in the storage unit 5.

The medium-frame-image processing unit 17 performs a blurring process to each medium frame, in addition to the transparency process of each medium frame explained in the first embodiment. The operation of the medium-frame-image processing unit 17 is explained below.

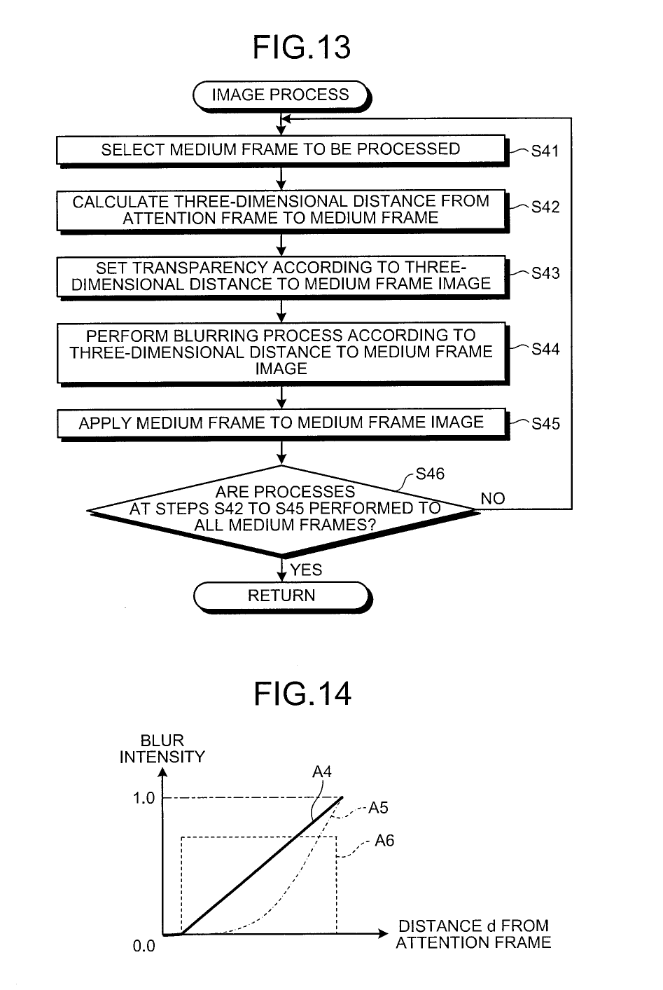

FIG. 13 is a flowchart of an order of the image processing executed by the medium-frame-image processing unit 17. The present process corresponds to the image processing (step S18) shown in FIG. 3.

First, the medium-frame-image processing unit 17 selects one medium frame from among medium frames, as a medium frame to be processed (step S41). The medium-frame-image processing unit 17 calculates the three-dimensional distance d from the attention frame determined at step S17 to the medium frame to be processed (step S42).

The medium-frame-image processing unit 17 then sets transparency of the medium frame image allocated to the medium frame to be processed, according to the three-dimensional distance d from the attention frame calculated at step S42 to the medium frame to be processed (step S43). Transparency is set in the same method as that explained in the first embodiment, and therefore detailed explanations of the method will be omitted.

The medium-frame-image processing unit 17 performs a blurring process to the medium frame image allocated to the medium frame to be processed, according to a value of the three-dimensional distance d calculated at step S41 (step S44).

The blurring process executed at step S44 is controlled by a method similar to that of the above setting of transparency. Specifically, as shown in FIG. 14, intensity of the blurring process performed to each medium frame can be controlled, by using blur processing models A4 to A6 having the three-dimensional distance d and the blur intensity uniquely related to each other. Relational expressions of the models A4 to A6 are similar to the above expressions (7) to (11), and therefore explanations thereof will be omitted. The relational expressions of the models A4 to A6 are stored in the ROM 2 or the storage unit 5 in advance.

In FIG. 14, the vertical axis of the graph expresses intensity of the blurring process, and “0.0” means that no blurring process is performed. When this numerical value is larger, the intensity of the blurring process becomes larger. That is, it can be controlled such that a blurring process is not performed to the medium frames around the attention frame and intensity of the blurring process is increased in the medium frames far from the attention frame. The medium-frame-image processing unit 17 can perform the blurring process using an image filter of a lowpass filter according to a frequency analysis method such as a fast Fourier transform (FFT) or a kernel filter of a block size of 3×3, 5×5, or the like.

Referring back to FIG. 13, the medium-frame-image processing unit 17 applies the image-processed medium frame image to the corresponding medium frame, thereby displaying the medium frame image in the display unit 6 (step S45).

The medium-frame-image processing unit 17 determines whether the processes at steps S42 to S45 are performed to all medium frames. When it is determined that a medium frame not yet processed is present (NO at step S46), the process returns to step S41 again, and the medium-frame-image processing unit 17 processes this medium frame. When it is determined at step S46 that the processes at steps S42 to S45 are performed to all medium frames (YES at step S46), the process proceeds to step S19 shown in FIG. 3.

As explained above, according to the second embodiment, plural image frames having relevance extracted from the image data can be simultaneously displayed in time series, and the image frames can be sequentially highlighted. Accordingly, a time flow of the image data can be displayed clearly, and users can be made conscious about each image frame. Consequently, users can be made conscious about the flow of the images such as a time relationship of the images.

When the blurring process is performed to each medium frame image according to the three-dimensional distance d from the attention frame, there is an effect that contrasts of the image on the medium frame other than the periphery of the attention frame decreases, and the image around the attention frame can be clearly observed. When transparency-processed frames are overlaid with each other by the blurring process, a ghost phenomenon that images on each medium frame appear simultaneously (a phenomenon that the same substance appears simultaneously at different positions) can be decreased. Therefore, the appearance of the total part-video-images can be improved.

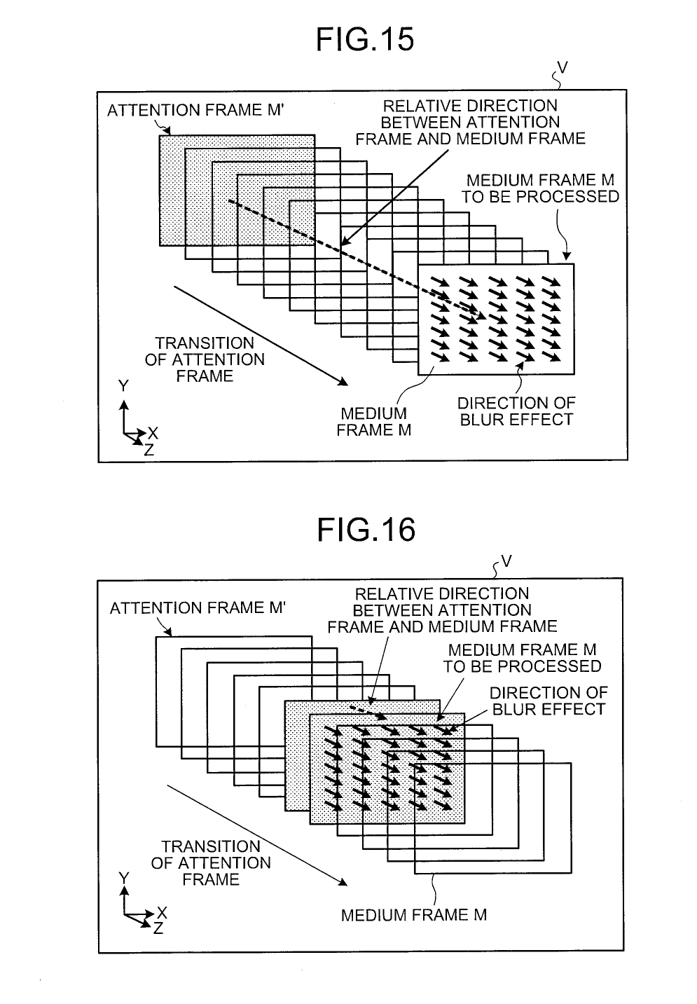

As a modification of the blurring process of each medium frame image, the blurring process can be performed in a specific direction. For example, as shown in FIG. 15, directionality of the blurring process can be controlled in the same direction as that of a vector (a relative direction) directed from a barycenter of the attention frame M′ to a barycenter of the medium frame M, thereby making users aware about the layout relationship between the attention frame and the medium frame.

As shown in FIG. 16, a direction of the blurring process can be determined based on a layout relationship between timely adjacent medium frames. In this case, users can be made conscious about the layout relationship between the medium frames, based on the directionality of the blur of the medium frame image. When the image frame is allocated to the medium frame in time sequences of video-image, the intensity of the blurring process can be changed according to a size relationship of time differences between the image frames. In this case, when the lateral axis of the graph shown in FIG. 8 is set as a distance between medium frames or a time difference between image times, control similar to the above can be performed. Users can be made conscious about both the layout relationship between medium frames and the time lapse.

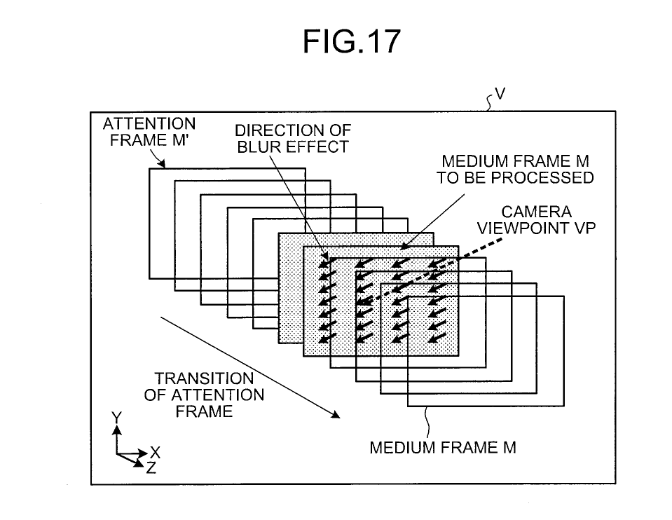

Alternatively, directionality of the blurring process can be determined from a layout relationship between a camera viewpoint (rendering viewpoint) of the virtual space in which medium frames are present and each medium frame. For example, as shown in FIG. 17, directionality can be determined by using a projection vector from a camera viewpoint VP to the medium frames M. The camera viewpoint VP means a position that becomes a viewpoint at the time of displaying the virtual space V. A layout of the medium frames M from this viewpoint is displayed in the display unit 6.

In this case, when the lateral axis of the graph shown in FIG. 14 expresses a distance from the camera viewpoint VP to each medium frame M, image processing around the attention frame M′ can be performed to the medium frame image of each medium frame, by only changing the position of the camera viewpoint VP (this is also applied to the case where a group of medium frames is rotated), without changing the layout of the medium frames M laid out within the virtual space V.

In performing the blurring process having directionality, a known method can be used. For example, an anisotropic filtering using an anisotropic block (for example, see J. Loviscach, Motion Blur for Texture by Means of Anisotropic Filtering, Eurographics Symposium on Rendering, pp. 105-110 (2005)), or a blur processing method of an image base (for example, see G. Brostow et al., Image-based motion blur for stop motion animation, Proceedings of the 28^{th} annual conference on Computer graphics and interactive techniques, pp. 561-566 (2001)) can be used.

While the blurring process (step S44) is performed after the transparency process (step S43) in the second embodiment, the order of the processes is not limited to this. Specifically, the order of the process at step S43 and the order of the process at step S43 can be replaced.

While the blurring process (step S44) and the transparency process (step S43) are performed in the second embodiment, only the blurring process can be performed when medium frames are laid out by avoiding overlay, for example. In this case, image processing is performed by excluding the process at step S43.

In the second embodiment, the transparency process and the blurring process are performed to the image frame allocated to each medium frame, according to a distance from the attention frame to the medium frame other than the attention frame. However, the process is not limited to the above. For example, at least one of the transparency process and the blurring process can be performed to the image frame allocated to each medium frame, according to each time difference from the image time of the image frame allocated to the attention frame to the image time of the image frame allocated to the medium frame other than the attention frame.

In this case, when the lateral axis of the graph shown in FIG. 8 and FIG. 14 expresses a time difference from the image time of the image frame allocated to the attention frame to the image time of the image frame allocated to another medium frame, the image processing of highlighting the medium frame image of the attention frame can be performed to the medium frame image of each medium frame, like in the above example.

An image processing apparatus according to a third embodiment of the present invention is explained next. Constituent elements similar to those in the first embodiment are denoted by like reference numerals, and explanations thereof will be omitted.

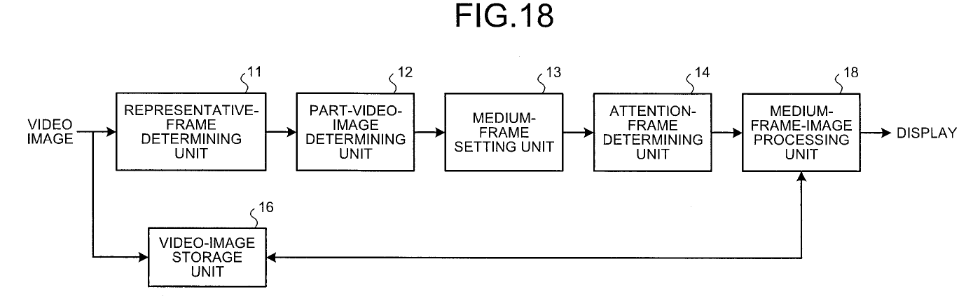

FIG. 18 is a block diagram of a functional configuration of the image processing apparatus 100 according to the third embodiment. As shown in FIG. 18, the image processing apparatus 100 includes a medium-frame-image processing unit 18 instead of the medium-frame-image processing unit 15 explained in the first embodiment, based on a control that the processor 1 performs to each unit following a predetermined program stored in the storage unit 5.

The medium-frame-image processing unit 18 performs a blurring process to each medium frame image according to a layout relationship between the attention frame and the medium frame, in addition to the image processing (the transparency process) explained in the first embodiment. In executing the blurring process, the medium-frame-image processing unit 18 determines whether the attention frame and the medium frame are overlaid on the screen. When it is determined that the attention frame and the medium frame are overlaid on the screen, the medium-frame-image processing unit 18 performs the blurring process to hold characteristic features of the overlaid part of the medium frame images. The operation of the medium-frame-image processing unit 18 is explained below.

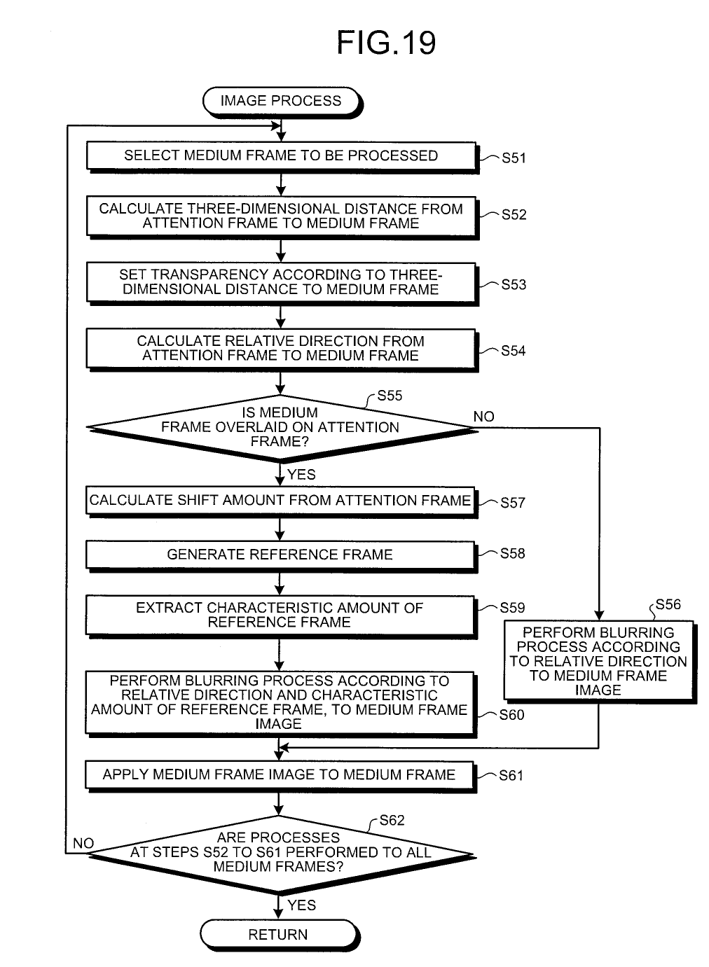

FIG. 19 is a flowchart of an order of the image processing executed by the medium-frame-image processing unit 18. The present process corresponds to the image processing (step S18) shown in FIG. 3.

First, the medium-frame-image processing unit 18 selects one medium frame from among medium frames, as a medium frame to be processed (step S51). The medium-frame-image processing unit 18 calculates a three-dimensional distance from the attention frame determined at step S17 to the medium frame to be processed (step S52).

The medium-frame-image processing unit 18 sets transparency of the medium frame image allocated to the medium frame to be processed, according to the three-dimensional distance from the attention frame calculated at step S52 to the medium frame to be processed (step S53). The setting of transparency is similar to that explained in the first embodiment, and therefore detailed explanations of this setting will be omitted.

The medium-frame-image processing unit 18 calculates an azimuth vector expressing the azimuth from the attention frame to the medium frame to be processed (step S54). The azimuth vector can be defined as the vector directed from the barycenter of the attention frame to the barycenter of the medium frame to be processed. When shapes of the medium frames are the same, the azimuth vector can be calculated from a vector connecting between the same positions of both frames, such as a vector connecting between the left upper positions of the frames.

The medium-frame-image processing unit 18 determines whether the medium frame to be processed is overlaid on the attention frame (step S55). When both the attention frame and the medium frame are quadrate objects, AND of the XY area of the attention frame and the XY area of the medium frame projected on the screen is taken, thereby determining whether both frames are overlaid with each other. When the CG object constituting the medium frame has a general shape such as a sphere or a cylinder, the medium-frame-image processing unit 18 determines about intersection of the screen projection areas of a bounding box including the medium frame, thereby determining whether both frames are overlaid with each other.

When it is determined at step S55 that the medium frame is not overlaid on the attention frame (NO at step S55), the medium-frame-image processing unit 18 performs the blurring process having directionality, to the medium frame image allocated to the medium frame to be processed, for all pixels or in a predetermined block pixel unit contained in the medium frame image, following the azimuth vector calculated at step S54 (step S56), and the process proceeds to the process at step S61.

On the other hand, when it is determined at step S55 that the medium frame is overlaid on the attention frame (YES at step S55), the medium-frame-image processing unit 18 calculates the amount of a positional deviation between the attention frame and the medium frame to be processed (step S57). The medium-frame-image processing unit 18 generates a reference frame expressing characteristic features of the medium frame image on the attention frame corresponding to the overlaid part (step S58).

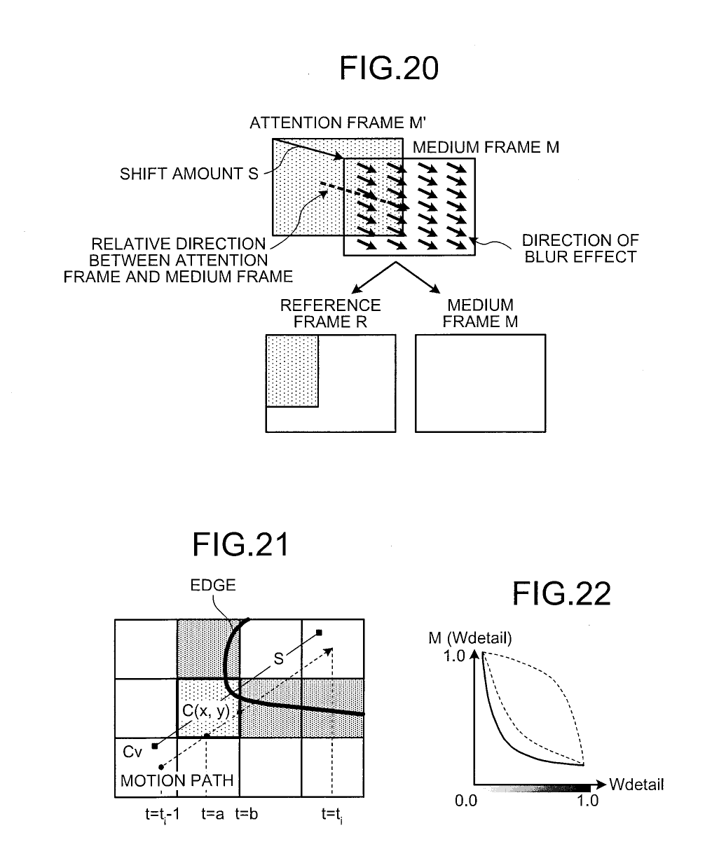

Generation of a reference frame is explained below with reference to FIG. 20. FIG. 20 is a schematic diagram for explaining the generation of a reference frame. First, the medium-frame-image processing unit 18 calculates a positional deviation amount of the X and Y directions of the attention frame M′ and the medium frame M to be processed, as a shift amount S. The shift amount S can be obtained as a vector amount having the azimuth vector obtained at step S54 projected to above the screen (X, Y plane).

The medium-frame-image processing unit 18 applies an image having the medium frame image on the attention frame shifted by the shift amount S, to the area corresponding to the overlaid part of the attention frame and the medium frame to be processed, within the frame having the same size as that of the medium frame, and generates this frame as a reference frame R. Positions on the generated reference frame R are related to positions on the medium frame M to be processed.

The medium-frame-image processing unit 18 stores the generated reference frame R into the video-image storage unit 16, thereby making it possible to reference all pixels contained in the reference frame R at the time of processing the next stage. While no image is present in the area other than that corresponding to the overlaid part in the reference frame R, a pixel value Q is set in this area.

Referring back to FIG. 19, the medium-frame-image processing unit 18 extracts a characteristic feature amount of the image (pixels) applied to the reference frame R (step S59). Specifically, an image is edge-extracted, by applying an edge detection algorithm based on the Laplacian method. An optional method of a Canny filter or the like can be use to extract the edge. The reference frame R can be converted to an image of a one-dimensional element expressing edge intensity. Alternatively, an edge extraction process can be performed to each color component of the image, and the obtained edge intensity can be stored in the video-image storage unit 16.

The medium-frame-image processing unit 18 then performs the blurring process to the medium frame image allocated to the medium frame to be processed, based on the azimuth vector calculated at step S54 and the characteristic feature amount extracted at step S60 (step S60). Specifically, each pixel of the image frame applied to the medium frame is filled based on the azimuth vector and the characteristic feature amount of the reference frame.

The blurring process at step S60 is explained below with reference to FIGS. 21 and 22. FIG. 21 is a schematic diagram for explaining the blurring process (filling process) at step S60.

At the time of defining the azimuth vector of each pixel of the medium frame image allocated to the medium frame to be processed (in this case, a uniform azimuth vector is applied to the whole screen), the medium-frame-image processing unit 18 calculates contribution of the azimuth vector applied to each pixel, as weight Wblur normalized in the total length of the azimuth vector, and sequentially adds a pixel value of the pixel becoming a starting point of the azimuth vector to each pixel. A pixel image corresponding to the attention frame is set to have priority, at a part having a large characteristic feature amount extracted from the reference frame, that is, the edge part of the image shifted from the medium frame image of the attention frame.

Specifically, the weight Wblur at each pixel of the medium frame can be calculated from the following expressions (12) and (13).

$$\begin{matrix}Wblur ( x , y ) = ( L / S ) \cdot M ( Wdetail ) & ( 12 ) \\ L = {\int }_{a}^{b} ( \sqrt{{( \frac{d x}{d t} )}^{2} + {( \frac{d y}{d t} )}^{2}} ) d t & ( 13 )\end{matrix}$$

In the expressions (12) and (13), “L” represents a length of an azimuth vector crossing the pixel to be processed, and “S” represents a total length of the azimuth vector. A function M is a correction function of edge intensity, and a nonlinear function expressed by the following expression (13) can be used. “Wdetail” means edge intensity of the reference frame, and γ is a correction coefficient.

FIG. 22 is a diagram illustrating a curve pattern expressed by the following expression (14). By changing the correction coefficient γ, the blur effect can be avoided by holding the edge in the reference frame, or the blur effect can be adjusted by highlighting the blur effect.

M=1.0−Wdetail^{γ} (14)

Each pixel value Cs (x, y) on the medium frame can be obtained from the following expression (15). Cv represents a pixel value that becomes a starting point of the azimuth vector, and δ is a correction coefficient. Cr (x, y) means a pixel value in the medium frame, that is, a corresponding pixel value on the attention frame.

Cs(x,y)=Cs(x,y)+Wblur(x,y)·Cv+δ(1.0−Wblur(x,y))·Cr(x,y) (15)

When the above calculation is performed to each of all pixel elements, the blurring process holding the characteristic features of the image frame at a overlaid part of the attention frame can be performed to the medium frame image allocated to the medium frame to be processed.

Referring back to FIG. 19, the medium-frame-image processing unit 18 applies the image-processed medium frame image to the corresponding medium frame, thereby displaying the medium frame image in the display unit 6 (step S61).

The medium-frame-image processing unit 18 determines whether the processes at steps S52 to S61 are performed to all medium frames. When it is determined that a medium frame not yet processed is present (NO at step S62), the process returns to step S51 again, and the medium-frame-image processing unit 18 processes this frame. When the medium-frame-image processing unit 18 determines at step S62 that the processes at steps S52 to S61 are performed to all medium frames (YES at step S62), the process proceeds to step S19.

When a point where plural medium frames are overlaid on the screen is looked at, the attention frame and the image frame overlaid with the attention frame are changed over in time series, along a lapse of time. It is known that when a blurred image (a blur-processed image frame) of a moving substance is combined with a normal image (an image frame not yet processed), contrast of the normal image increases (for example, see T, Takeuchi and K. De Valios, Motion sharpening in moving natural images, Journal of Vision, Vol. 2, p. 377, (2002)).

A peripheral medium frame image overlaid with the attention frame perceived based on a movement of a medium frame (a medium frame image) looked at by a user has high image correlation. This is equivalent to a movement of a blurred image (an image of low contrast). On the other hand, the background attention frame has high contrast. Therefore, highlight effect of contrast can be obtained from the relationship with the blur-processed medium frame image. That is, there is an effect that the medium frame image of the attention frame is highlighted without being conscious about the overlay between the medium frames.

As explained above, according to the third embodiment, plural image frames having relevance extracted from the image data can be simultaneously displayed in time series, and the image frames can be sequentially highlighted. Accordingly, a time flow of the image data can be displayed clearly, and users can be made conscious about each image frame. Consequently, users can be made conscious about the flow of the images such as a time relationship of the images.

When a part overlaid with the attention frame is blur-processed so that the image edge of the attention frame is held, the attention frame can be displayed without being interrupted by the medium frame present in the front. The blurred image finally obtained holds characteristic features of the attention frame. Therefore, the blur effect can be obtained, and the image component of the attention frame can be effectively reflected.

While the first to third embodiments of the present invention have been explained above, the present invention is not thereto, and various modifications, substitutions, and additions can be made without departing from the scope of the invention. In addition, any or all of the first to third embodiments can be used by combining them.

The program executed by the image processing apparatus according to the first to third embodiments is stored in the ROM 2 or the storage unit 5 in advance. Alternatively, the programs can be recorded in a computer-readable recording medium such as a compact disk read-only memory (CD-ROM), a flexible disk (FD), a compact disk recordable (CD-R), and a DVD, in an installable format or an executable format. The recording medium also includes a one to which a program transmitted from a local area network (LAN) or the Internet is downloaded or which temporarily stores the program, as well as a medium independent of the computer or a built-in system.

Middleware (MW) such as an operating system (OS), database management software, and a network operating on the computer based on an instruction of a program installed in the computer or a built-in system from the recording medium can also execute a part of each process to achieve the above embodiments.

The program executed by the image processing apparatus according to the first to third embodiments can be stored in a computer connected to a network such as the Internet, downloaded through the network, and provided. Alternatively, the program can be provided or distributed through a network such as the Internet.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image processing apparatus comprising:
a representative-frame determining unit that determines a representative frame from a series of image frames constituting image data;
a part-video-image determining unit that determines a part of a video image including a plurality of image frames relevant to the representative frames from the series of image frames;
a medium-frame setting unit sets a plurality of frames as a display medium of the image frame, within a display virtual space;
an allocating unit that allocates image frames contained in the part of the video image to each medium frame in time sequences of the video image, according to a layout relationship of the medium frames, the layout within the display virtual space;
an attention-frame determining unit that sequentially determines one attention frame from among the plurality of medium frames; and
an image processing unit that performs image processing of highlighting an image frame allocated to the attention frame, to an image frame allocated to each medium frame.

2. The apparatus according to claim 1, wherein the image processing unit performs at least one of a transparency process and a blurring process to an image frame allocated to each medium frame, in intensity according to a distance from the attention frame to a medium frame other than the attention frame.

3. The apparatus according to claim 1, wherein the image processing unit performs at least one of a transparency process and a blurring process to an image frame allocated to each medium frame, in intensity according to a time difference of image times from an image frame allocated to the attention frame to an image frame allocated to a medium frame other than the attention frame.

4. The apparatus according to claim 2, wherein the image processing unit determines at least one of a direction of blurring the image frame and intensity, according to a layout relationship between the attention frame and a medium frame other than the attention frame.

5. The apparatus according to claim 3, wherein the image processing unit determines at least one of a direction of blurring the image frame and intensity, according to a layout relationship between the attention frame and a medium frame other than the attention frame.

6. The apparatus according to claim 2, wherein the image processing unit performs a blurring process of holding characteristic features of an image frame allocated to the attention frame, to an image frame allocated to a medium frame other than the attention frame, according to a layout relationship between the attention frame and the medium frame other than the attention frame.

7. The apparatus according to claim 3, wherein the image processing unit performs a blurring process of holding characteristic features of an image frame allocated to the attention frame, to an image frame allocated to a medium frame other than the attention frame, according to a layout relationship between the attention frame and the medium frame other than the attention frame.

8. The apparatus according to claim 6, wherein the image processing unit performs a blurring process to an image frame allocated to the medium frame other than the attention frame, using an image element of an edge part contained in an image frame allocated to the attention frame.

9. The apparatus according to claim 7, wherein the image processing unit performs a blurring process to an image frame allocated to the medium frame other than the attention frame, using an image element of an edge part contained in an image frame allocated to the attention frame.

10. The apparatus according to claim 1, wherein the image processing unit performs at least one of a transparency process and a blurring process to an image frame allocated to each medium frame, in intensity according to a distance between medium frames to which timely adjacent image frames are allocated.

11. The apparatus according to claim 10, wherein the image processing unit determines at least one of a direction of blurring the image frame and intensity, according to a layout relationship between medium frames to which timely adjacent image frames are allocated.

12. The apparatus according to claim 1, wherein the medium-frame setting unit disposes the medium frames based on a content of image frames contained in the part of the video images.

13. The apparatus according to claim 1, wherein the medium-frame setting unit sets a layout, a posture and a shape of each medium frame, in a three-dimensional virtual space.

14. The apparatus according to claim 13, wherein the medium-frame setting unit sequentially disposes the medium frames in the virtual space so that the medium frames are at different positions in the depth direction, and
the allocating unit allocates image frames contained in the part of the video images in time sequences of the video image, from the back toward the front medium frames within the virtual space.

15. The apparatus according to claim 14, wherein the attention-frame determining unit sequentially determines one attention frame, from the back toward the front medium frames within the virtual space.

16. The apparatus according to claim 1, wherein the part-video-image determining unit determines the representative frame and a predetermined number of image frames located before and after the representative frame, as the part of the video images.

17. The apparatus according to claim 1, wherein the attention-frame determining unit sequentially determines one attention frame from among the plurality of medium frames in time series of image times, based on image times of image frames allocated to each the medium frames.

18. An image processing method comprising:
determining a representative frame representing image data from a series of image frames constituting the image data;
determining a part of a video image including a plurality of image frames relevant to the representative frames from the series of image frames;
disposing a plurality of frames as a display medium of the image frame, within a display virtual space;
allocating image frames contained in the part of the video image to each medium frame in time series of image times, according to a layout relationship of the medium frames;
sequentially determining one attention frame from among the plurality of medium frames; and
performing image processing of highlighting an image frame allocated to the attention frame, to an image frame allocated to each medium frame.

19. The method according to claim 18, wherein, in the performing image processing, at least one of a transparency process and a blurring process is performed to an image frame allocated to each medium frame, in intensity according to a distance from the attention frame to a medium frame other than the attention frame.

20. The apparatus according to claim 18, wherein, in the performing image processing, at least one of a transparency process and a blurring process is performed to an image frame allocated to each medium frame, in intensity according to a time difference of image times from an image frame allocated to the attention frame to an image frame allocated to a medium frame other than the attention frame.
